(19) United States
(12) Patent Application Publication
(10) Pub. No.: US 2014/0058917 A1
(43) Pub. Date: Feb. 27, 2014

(54) Method for trade and exchange of expert information, including prognosis or prediction opinions

(71) Applicant: ALEKSANDR A. VOLKOV, SAN FRANCISCO, CA (US)

(72) Inventor: ALEKSANDR A. VOLKOV, SAN FRANCISCO, CA (US)

(21) Appl. No.: 13/477,445

(22) Filed: May 22, 2012

(51) Int. Cl. G06Q 40/04

(52) U.S. Cl. CPC G06Q 40/04
USPC 705/37

(57) ABSTRACT

System and method for providing a forum or platform for its users to share their own market analysis and predictions, and to receive the same sort of information from others. This exchange of information to be done electronically, via Internet, other information networks. The system to consist of a set of databases, storing and tracking each user's history of predictions, for its timing, accuracy, character; user profiles for their success rate, frequency of usage, safety and clearance from the insider trading. The system further to allow the users, with proven above-average success rate, to sell their predictions to the public, thus liberating the access to financial expert knowledge: both for the providers, who do not possess power to run their own consulting firm, and for the users of the content, who don't want to purchase expensive subscriptions from one analyst but would rather micro-purchase singular predictions from many providers.

### CROSS-REFERENCE TO RELATED APPLICATIONS

Not applicable.

### FEDERALLY SPONSORED RESEARCH

Not applicable.

### TECHNICAL FIELD OF THE INVENTION

This present invention relates to the system and method of electronically provided exchange of the users' knowledge and expertise. Particularly, this system and method allow to liberate one of the areas of the informational exchange, not yet touched by the social networking and the usual openness of the Internet—the exchange of expert knowledge about the financial markets, including, but not limited to, the stock-exchange, option-trading, commodity and currency trading markets.

This invention resolves two problems currently existing in the field of financial expert information:
1. The limited availability and ineffectiveness of such information due to (a) its high cost; (b) absence or hindrance of particular expert's history of success; (c) severe de-centralization of the content providers.
2. Legal protections (a) of confidentiality of the publicly-traded companies; (b) of the scope of the duties of the professional financial advisors and analytics; and (c) against the insider trading.

The proposed system provides a safe and legal platform for both the providers and consumers of the financial expertise, to trade and exchange such expertise in an unhindered way, at a fraction of cost, currently charged for the “expert” subscriptions. This approach liberates access to the information for the consumers and, at the same time, provides a conduit for the non-professional experts to deliver their expertise to a wide spectrum of users.

### BACKGROUND OF THE INVENTION

The informational exchange evolves toward inter-connectivity and social networking, and at a great pace. More and more areas of knowledge become “socialized” and Internetialized. What successfully started from just a method of selling your things online on a global-scale flea-market (ebay.com or amazon.com,) evolved in many other forms of exchange and collaboration, such as a world's own-made encyclopedia (wikipedia.org,) global communities of friends (facebook, linkedin, google+,) and many other specialized sub-market and niche-groups, prospering on user-to-user exchange of some industry or idea, be it a car rental, extra tickets to a concert, or a vacant room for a weekend in another country.

One area though remains untouched throughout these years of social and Internet revolution—an area of trading the financial expertise. The main roadblocks, against the implementation of the system to allow unhindered exchange of this product, are: the legal constraints and the high cost of entry for a would-be provider. This invention provides a solution, which eliminates the cost barrier, while remaining in compliance with the applicable legal requirements.

### PRIOR ART

This invention deploys the elements of the prior art, as follows:

1. This system will operate a web-based platform (or “forum”) for its users to exchange information, by either posting one user's own piece of advice (the incoming flow from the “providers”,) or by selecting and accepting such advice from someone else (the outgoing flow to the “consumers”.) The same user can be both a provider and a consumer within the forum.

2. This system will track the performance and the history of activity of its users, including the amount of the posted pieces of advice, its rate of success, its frequency, its subject matter and zone/kind of coverage, user's feedback, and other similar characteristics.

3. This system will track and confidentially store the contractual information about each user, including measures taken to assure user's compliancy with the applicable laws, user's agreed-to contracts and regulations between the user and the system, user's payment performance, user's profile information, including the user's history of employment and association with any publicly traded entities, financial advising companies, financial institutions, news companies, institutional traders and alike. If any user's affiliation with the entities similar to the listed above will be detected, such user will not be allowed to be a “provider” of any information.

4. This system will deploy all common and available methods of the online payment transfers, in order to provide the system users with the ability to pay each other.

5. This system will be made by the available software development means (programming languages and the database “engines”).

6. This system will utilize computer-based Internet browsers or “platforms” available for the web-connected devices, including, without limitation, the desktop and laptop computers, cellular “mobile” phones, tablet computers, television sets, game systems, and any other web-based devices.

However, despite the above-mentioned borrowing of the already existing solutions, it is the particular combination of these elements, and the method of use thereof, defines this invention. No prior art exists insofar as a successful solution for a viable online platform allowing to trade and exchange legally the financial expertise between the large, random amount of users.

### Advantages

This invention provides the “missing piece of a puzzle”—a solution to let public benefit from the power of crowd-sourcing and Internet social-networking in a field of financial analysis and practical, commercial application of the crowd-sourced financial expertise.

### Economic Advantage

The principal advantage of this system is in its economics. The invention aims to affect economically the system's users, but there is also an advantage for the global markets and trading exchanges, as demonstrated below.

The system is inhabited by its “users”—the individuals, registered with the system's database and granted access to the information, or, additionally, a right to submit its own information. Users produce and consume the information through the system. As mentioned above, the system recognizes two types of the user's status: the provider and the consumer. Each type receives its own advantages, unique for its class.

The providers are the system's users, who will provide the information—their predictions, prognosis, or opinions about the different markets. They will be able to sell their information, using the Invention. The advantage for the providers comes in several shapes and forms: first, it will not cost anything for a provider to start offering and selling the information, the cost of entry—although not entirely free—will not request any monetary investment from the providers. What will be required is the providers' diligent commitment, compliance with the rules, and quality of their output, so that it will be desired and trusted by the user-consumers. Second, the providers will receive an opportunity to benefit from their knowledge and expertise, by selling their advice. Thus, anyone who has the talent, ability, and skill to make a sound financial prediction, can become a professional financial analyst, without any other entry requirement but one's own qualities. Whether that one will make a full-time living out of this vocation, or a part-time side-hobby, this invention will provide the means and tools to deliver and sell that provider's opinion to the system's audience.

The consumers are the system's “users” who receive the information. This invention gives them an advantage in a form of receiving up-to-date financial expert information, combined from multiple sources (users-providers) and custom-priced for the particular needs of a particular user, at that particular moment. Just like the potential advisors, who currently prevented from generating income by the high cost of entry, or by a high burden of prerequisites, the potential consumers' appetites for the financial analysis are also economically curtailed: not only each and every advisor charges monthly subscriptions for her services, but these subscriptions only buy that one—or limited few—advisor's opinion. Outside of this invention, if a consumer wants to compare two or more of the advisors, consumer has to pay for each additional subscription, and even conglomerating and averaging services, which assemble a composition of several experts' opinions, do it based on the limited set of established choices. This obstacle is not the only one. Consumers rarely have an accurate way to track the advisor's performance (besides the self-promoting statistics, published by the advisor), consumers cannot control the kind, the amount, and the frequency of the information they buy with their subscriptions—it is an all-or-nothing approach; and it is often the case that the lion share of the purchased advice is not needed and remains unused by the consumer.

This invention resolves these obstacles, through the way its output of the information is structured—not only it comes submitted from multiple sources/providers, virtually an unlimited pool and each instantly verifiable for his/her track of performance, but the consumer can also choose the amount of advise it wants to receive, in what fields or markets, on what scale, and with what frequency. A passive investor, who needs to check-in once a month for an advice in one particular area, so to buy a long-term investment on his monthly allowance, will have a drastically different plan and correspondingly minimal payment, in comparison to a day-trader, active in several fields, who needs to make informed decisions on a minute basis. Yet, for the day-trader like the described above, utilizing this invention will still be beneficial, because of the ability to target and fine-tune the flow of the desired advice.

Markets at large will also benefit from this invention, indirectly, because this invention fosters the trading and procures more transactions and orders to be made.

### Public Interests' Advantage

Additionally, this invention works toward the public interests. From the user-consumers standpoint, the invention provides for more members of a better-informed public, freely exchanging their ideas in the area, where such exchange was hindered before.

### CONCLUSION

This invention, by eliminating high-cost barriers for entry for both providers and consumers, securing the effective safety control against both the insider trading and the random unskilled rumor-spoilers, and by connecting those who want to share their knowledge and market vision with those who want to know, offers an effective method for people to trade in their own knowledge and expertise, to be an independent, agenda-free, source of financial information; available for everyone who is willing to listen.

### SUMMARY OF THE INVENTION

This invention offers a forum for providers and consumers of financial analysis information, to engage in exchange of such information, directly, without any unnecessary barriers in between them.

In accordance with one embodiment of the invention, in server-client digital database model, to function, the invention requires a server-based database management system with software making inquiries and submitting entries of data to the database. Users will connect to the system by user's terminals (computers, phones, tablets, or similar devices), and will communicate with the system's server by invoking an inquiry mechanism.

There will be a distinctive label for every marketable event, and all exchange of the information will be primarily sorted and delivered, organized by those labels: providers of information will store it ear-marked against its related labels, and consumers will request it by the same labels.

### DETAILED DESCRIPTION

### First Embodiment

### Implementation of the System to Serve Analysis of Financial Markets

The main denominational unit of this exchange system is an “advice”—a single piece of opinion, consisting of 3 set parameters: subject, its change, and the timing of the change. In other words, the “advice” is a prediction of one tradable element's single change in the defined future moment of time. “Tradable element”, or subject of the advice, is defined as anything legally traded at the current exchange markets: common stock, stock's options, indexes, future contracts, commodity indexes, currency indexes, equity-traded funds, etc. “Single change” is defined as one not-compound change of state, such as increase or decrease, in value, volume, volatility, or any other traceable quality, optionally predicted in numeric or percentage measurement (exact measurements are not required, because the change may be predicted without a set end-result). “Defined future” means the timing of the element's change, for when the opinion's author sees this particular Single Change will take place. For instance, it is material for anyone interested to learn that the index XYZ [Element] will decrease [Change] that the anticipated change will take place tomorrow, in 3 months, or at once [Date].
Those members of the forum who make predictions, the providers of the information, pack or shape their opinions in the format described above. Whether the opinion will be as generic as predicting the entire Nasdaq index to go down in a month, or as specific as predicting a certain call-option on Apple stock, one which matures at certain date, to go up before the end of today's session, each one of those formed opinions, once created in the system and submitted to its database, will be that elemental “advice”, an item to be exchanged by means of this invention, now to be offered to the consumers' side of the system's users.
Those members of the forum who consume the financial analytical expertise will order and receive such knowledge in the same granular mode, the advices, created for them by the providers. Just as the providers are not limited in creating any particular advice, the consumers are not obligated to accept any particular advice at all. The consumers enter the forum by posting their preferences in a form of a search query, thus pooling what is available in the system to cover their particular area of interest(s). Those requests are also let known to the providers, indicating to them what fields are in need for an advice. Consumers may, and will, create their customized subscriptions, for whatever tradable elements or market events they are interested in, so to receive a constant flow of all advice, selected by the chosen criterion.
Both sides of the community are therefore constantly synchronizing, in what predictions are available and which are needed. It helps providers to narrow their efforts alongside of what is requested and will be more likely consumed, and it assures consumers to have available advice for any request they may put out.
As it is easily seen from the above description, the consumer rules and controls this forum, by setting the trends of what information will be most requested—a major distinctive feature of this invention as opposed to the classic, currently employed scheme, where an expert handles down his opinions to the subscribers, in whatever scope, shape, frequency, or detail that expert chooses. Here, the consumer sets the boundaries, criteria, demand, and even a price for the expert's opinion, and this shift of authority allows for a unprecedented flexibility in the industry of informational expertise.
There are other sets of checks and balances available for implementation with this invention. First, the system of feedback, for either side of the users, will signal the next person, whether this particular provider or consumer is reliable enough to deal with. Second, the internal system of filtering provider's backgrounds for potential conflicts of interest, unpermitted disclosures, history of user's engagement or employment with any organizations or entities, which would prohibit such person from rendering an advice; current status of all licenses and compliance regulations, whichever required. Third, the entire usage of the system will be done under complete anonymity of its user-consumers, their identities being confidentially protected, and users' “nicknames” used instead. The same level of protection may or may not be beneficial for the user-providers, although entirely possible on the technical level of this invention, it may be though required from the legal standpoint that those who provide their advice will have to operate under their actual name, fully disclosed. Lastly, the power of users' feedback will put an additional constrain against unreasonable behavior or potential damage an unscrupulous advisor may cause—providers with zero, little, or negative feedback will have lesser chance to be followed, or that their advice will be accepted by anyone, even at no charge or as a rumor; additionally, the system operator should not allow such providers to sell their advice, only authorizing the time-proven and well performing providers to be able to offer their advice for sale. As a coincidence, if someone will have a sudden urge for “whistle-blowing” and to leak confidential insider's information on any particular market event, that attempt will not gather any specific attention if comes from an non-reputed source, while those providers, who gained their reputation through hard work and constant performance, will be self-restrained from repeating or relaying on an unverified rumor.
The embedded security system has thus lead the inventor to name the proposed first embodiment of the invention as “Exyder,” as opposed to the prohibited, “insider” trading. In other embodiments of this invention, even where the concept of insider trading is not so developed, such as sport betting, the described above security mechanism will still work and provide for a more authentic, fair, and legit environment of expertise trading.

### Operation

### First Embodiment

The operation of this first embodiment requires the database and command software language for depositing information and making inquiries. It is commonly resolved by utilizing the “SQL” languages and databases, a standard designed for managing data in relational database management systems. Any of the existing SQL languages will suffice for implementation of this invention. Other (non-SQL) query languages will equally suffice, for instance, SPARQL, as an example of many.

Database for this invention stores several sets of data, related to each other. First set is the block of information about users: its contact information, performance history, payment information and history, their stored preferences, contacts within the system, received advices (for each user-consumer), and made advices (if such uses is also a provider), user's feedback. Second set manages the created elements of the exchange, the advices, information of their authors and users (related, coming from the first set), its parameters (subject and its predictions), the success or failure of its prediction (in comparison with the real-world information of the already happened market's performance).

The usage of this invention requires input and output of information to and from the relational database. All users first have to register with the system, thus entering their contact information to the database, obtaining username and password, and, additionally for the providers, clearance to operate. Each consumer-user starts by entering a search query, setting the parameters this user is interested in, this query results in both pulling the available information from the existing database of advices, and also enters to the database this user's query as desired parameters, setting an invitation for the users-providers to speculate on the set subjects and to create new advice(s).

Graphical user interface (“GUI”) will be designed to simplify user's experience and operation of the system, in order to (a) maximize user's productivity in the least required time for either entering a new advice or obtaining the solicited information; and (b) to be equally available on as many Internet-connected devices as possible, remaining easy to use for even technically-limited or graphically-challenged devices. In particular, user-provider may filter which consumer's requests to see on her screen (for instance, if the certain provider is specializing only in observing medical industry, it may filter out requests for any other industry and save her time from reading requests she may not address). User-provider will also be able to create multiple advices at once, if, for example, the provider is sure about all blue chips rising tomorrow, it may create a blanket advise for all related indexes, stock, options, and funds, without clicking on each ticket separately.

Similar simplicity meets the consumer-user: ability to order advices in bulk, per certain set criterion of factors (show me all advices for what will increase in volume in the next hour), ability to filter incoming advices from certain industries, certain countries of exchange (only US, or Japan, or Europe exchanges), certain providers (may be to decide not to receive new advice from a certain user who failed too often in the past), etc. Users can make single purchases of choice, or to shape a pre-programmed selection as a subscription, to receive all advices within set requirements on a regular basis, the regularity or frequency of which is yet another parameter users are at freedom to set.

The operation is designed to be offered on a non-stop, permanent basis, not only because there is almost always some trading takes place somewhere on the planet, but also because the connection between users does not stop with a trading bell: people still can make or consume predictions for the future sessions.

The system's operator is expected to make profit by collecting a fraction of the price of each advice sold. There are, however, other venues of potential income for the system's operator, such as profiting from advertising on the system's frequently visited web-pages. Moreover, the system does not require being commercial for it to operate—the exchange of advices may be performed on an entirely non-profit basis.

The trade is made possible by indicating possible desired value of the sale for the purchaser. In this embodiment's implementation, it means that the advice's value must be shown without or before the disclosure of the actual advice's substance. It is achieved by masking one of the three advice's components from the receiving consumer before that consumer makes the purchase. For instance, an advice may demonstrate that certain, undisclosed stock in the consumer's desired field will grow, or, that the certain stock 123ABC will change somehow its position, but only after the purchase, consumer will receive the full informational set of the advice, that is what, when, and how.

Inventor proposes for the first embodiment, to be attractive for the users and to make economic sense, to charge commission only on the sales of such advice, which turned out to be true. In other words, if user X predicts that stock 123ABC will go down tomorrow, and user Y buys that advice, but the stock goes up instead, the user Y will be refunded its money (which the system will hold but not yet made available for X) and both the system and user X will not make money on the failed advice.

### CONCLUSION, RAMIFICATIONS, AND SCOPE

As demonstrated above, at least one embodiment of the invention provides a more economic and productive method of exchange of financial analytical information, in the field where crowd-sourcing and power of social networking was not yet productively utilized. Yet for its implementation, this embodiment does not require an invention of new technology—all necessary elements, methods of user management, and methods of operating the data exchange (SQL) already exist today. The substance of this invention is the compilation of the available materials, so that the resulting system allows people to trade their financial analysis expertise freely.

There is an equally large number of possible ramifications of this invention. Due to untested variations in possible user management, subscription based or “ad hoc”, professional or crowd-sourced providers, inquiries made by user voluntarily logging-in or via a “push” to the subscribed devices without confirmation, these ramifications have not been developed into separate embodiments or applications.

Ramifications also include the different ways for translating the above-described system for trading gaming predictions, for instance, predictions for sport events, races, or tournaments of any kind. Ramifications further may include translations of the system into different languages, as well as its implementation on a off-line basis, for an internal use without any connection to the Internet.

Embodiments of this invention may have a joint version of this system, combined with the actual trading platform or mechanism to act and execute on the received advice(s), making market sales and purchases of the underlying subject of the advice.

Another embodiment of this invention may be a service of an investor's portfolio review—where the consumer-user will let system know what position she holds and receive the system's collection of advices with predictions about such positions. This process can be automated so that the consumer-user receives instant updates and changes in prognosis regarding positions she holds or intends to hold.

Accordingly, the scope should be determined not by the first embodiment described above, but by the appended claims and their legal equivalents.

I claim:

1. A method of exchanging analytical information:
a. providing means for the one set of method's users to form their opinion about a certain event, for event's predicted change of its stage, at some defined point in the future, and
b. providing the means for the other set of method's users to receive such formed opinion, and
c. the single element of the informational exchange to be defined and structured as a defined prediction of a certain event, to change in a certain way, at a certain time, and
d. storing the users' information and the formed elements of the informational exchange in the accessible database, and
e. providing the set of pre-defined patterns for safety and compliance with applicable laws, eliminating and blocking unwanted or restricted flow of information, and
f. providing such set of pre-defined patterns for user's interface, for user to execute functions of performing informational exchange, user account management, and
g. providing the system, which will track the informational exchange, will allow the monetary exchange be correspondingly executed in order for the providers to be compensated, and to allow system's operator to receive income by drawing a fraction of the purchases' price as a commission for each successful trade.
